(19) United States
(12) Patent Application Publication
(10) Pub. No.: US 2021/0209441 A1
(43) Pub. Date: Jul. 8, 2021

(54) COMPARING PERFORMANCE OF VIRTUAL ASSISTANTS

(71) Applicant: International Business Machines Corporation, Armonk, NY (US)

(72) Inventors: Gandhi Sivakumar, Bentleigh (AU); Vasanthi M. Gopal, Plainsboro, NJ (US); Garfield W. Vaughn, South Windsor, CT (US); Malarvizhi Kandasamy, Bangalore (IN)

(21) Appl. No.: 16/734,732

(22) Filed: Jan. 6, 2020

(51) Int. Cl. G06N 3/00; G06N 5/04

(52) U.S. Cl. CPC G06N 3/006; G06N 5/04

(57) ABSTRACT

A system and method compare performance of virtual assistants. A user selects metrics for evaluating two or more virtual assistants, and these metrics may be weighted by the user. One or more chat sessions from each virtual assistant are then analyzed using the weighted metrics to generate a score for each chat session. The scores of chat sessions of different virtual assistants are then compared according to the selected weighted metrics, and a recommendation of a virtual assistant may be made based on the score comparison. The evaluation of multiple virtual assistants allows comparing these virtual assistants to determine which provides the better customer service according to the selected weighted metrics.

### BACKGROUND

### 1. Technical Field

This disclosure generally relates to virtual assistants, and more specifically relates to comparing performance of multiple virtual assistants.

### 2. Background Art

Customer support systems have evolved over the years. Many early systems that required human operators to answer incoming telephone calls from customers have been replaced by newer systems that use automated voice-prompt systems that allow routing telephone calls to the correct people for handling those calls. For example, a customer that places a call to a business may be greeted with an automated voice prompt, such as “For Sales, press 1. For Customer Service, press 2. For all other inquiries, press 3.”

An alternative to providing customer support via telephone calls is to provide customer support via an online chat system. Early online chat systems provided a chat dialog between a human customer support person and a user who initiates the chat. More recent online chat systems provide a chat dialog between a virtual, computer-generated assistant and a user who initiates the chat. In these systems that use virtual assistants, the quality of the customer support is determined by how effectively a virtual assistant can provide the needed support.

### BRIEF SUMMARY

A system and method compare performance of virtual assistants. A user selects metrics for evaluating two or more virtual assistants, and these metrics may be weighted by the user. One or more chat sessions from each virtual assistant are then analyzed using the weighted metrics to generate a score for each chat session. The scores of chat sessions of different virtual assistants are then compared according to the selected weighted metrics, and a recommendation of a virtual assistant may be made based on the score comparison. The evaluation of multiple virtual assistants allows comparing these virtual assistants to determine which provides the better customer service according to the selected weighted metrics.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a computer system that includes a virtual assistant comparison tool;

FIG. 2 is a table showing some possible metrics that may be used by the virtual assistant comparison tool to evaluate virtual assistants;

FIG. 3 is a block diagram of one specific implementation of a virtual assistant comparison tool;

FIG. 4 is a flow diagram of a method for comparing virtual assistants;

FIG. 5 is a flow diagram of a method that uses the score comparison of virtual assistants to recommend a virtual assistant based on the scores;

FIG. 6 is a first sample chat dialog between a first virtual assistant and a user;

FIG. 7 is a first sample chat dialog between a second virtual assistant and a user;

FIG. 8 shows the metrics selected by a user for evaluating first and second virtual assistants that produced the sample chat dialogs in FIGS. 6 and 7;

FIG. 9 shows the metrics selected in FIG. 8 after the user weights the selected metrics to provide weighted selected metrics;

FIG. 10 shows scoring of the chat dialog of VA1 shown in FIG. 6;

FIG. 11 shows scoring of the chat dialog of VA2 shown in FIG. 7;

FIG. 12 is a second sample chat dialog between a first virtual assistant and a user;

FIG. 13 is a second sample chat dialog for a second virtual assistant and a user;

FIG. 14 shows the metrics selected by a user for evaluating first and second virtual assistants that produced the sample chat dialogs in FIGS. 12 and 13;

FIG. 15 shows the metrics selected in FIG. 14 after the user weights the selected metrics to provide weighted selected metrics;

FIG. 16 shows scoring of the chat dialog of VA1 shown in FIG. 12; and

FIG. 17 shows scoring of the chat dialog of VA2 shown in FIG. 13.

### DETAILED DESCRIPTION

A system and method compare performance of virtual assistants. A user selects metrics for evaluating two or more virtual assistants, and these metrics may be weighted by the user. One or more chat sessions from each virtual assistant are then analyzed using the weighted metrics to generate a score for each chat session. The scores of chat sessions of different virtual assistants are then compared according to the selected weighted metrics, and a recommendation of a virtual assistant may be made based on the score comparison. The evaluation of multiple virtual assistants allows comparing these virtual assistants to determine which provides the better customer service according to the selected weighted metrics.

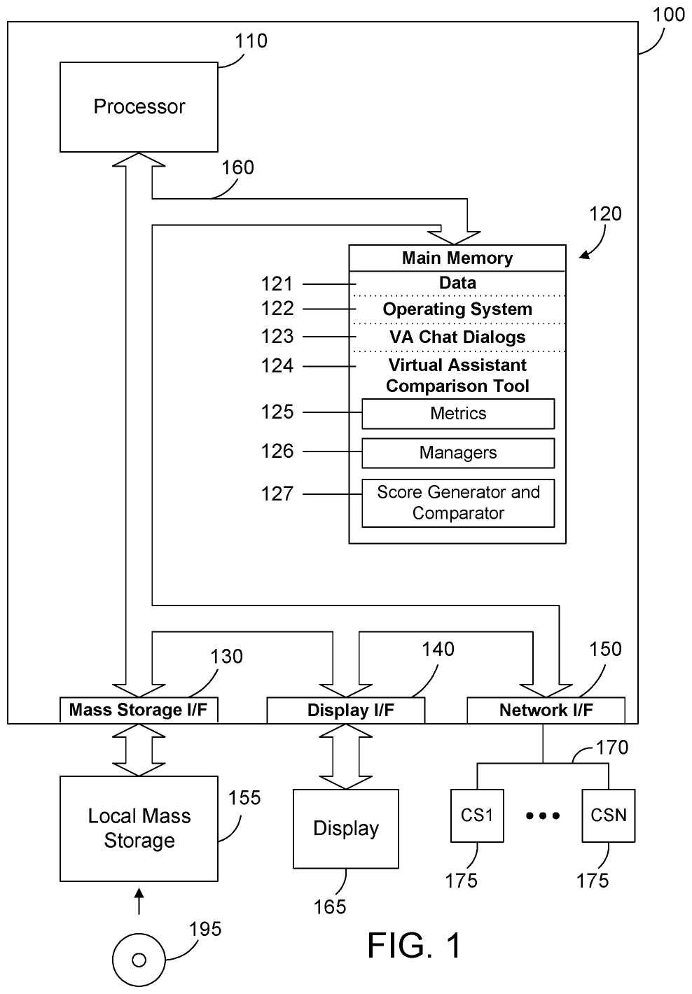

Referring to FIG. 1, a computer system 100 is one suitable implementation of a computer system that includes a virtual assistant comparison tool as described in more detail below. Computer system 100 is an IBM POWER9 computer system. However, those skilled in the art will appreciate that the disclosure herein applies equally to any computer system, regardless of whether the computer system is a complicated multi-user computing apparatus, a single user workstation, a laptop computer system, a tablet computer, a phone, or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as local mass storage device 155, to computer system 100. One specific type of local mass storage device 155 is a readable and writable CD-RW drive, which may store data to and read data from a CD-RW 195. Another suitable type of local mass storage device 155 is a card reader that receives a removable memory card, such as an SD card, and performs reads and writes to the removable memory. Yet another suitable type of local mass storage device 155 is universal serial bus (USB) that reads a storage device such as a flash drive.

Main memory 120 preferably contains data 121, an operating system 122, virtual assistant chat dialogs 123, and a virtual assistant comparison tool 124. Data 121 represents any data that serves as input to or output from any program in computer system 100. Operating system 122 is a multitasking operating system, such as AIX or LINUX. The virtual assistant chat dialogs 123 can include chat dialogs of past interactions of virtual assistants, and can additionally include real-time chat dialogs that are analyzed by the virtual assistant comparison tool 124 as they occur. The virtual assistant comparison tool 124 includes: a set of metrics 125 that are used to measure a virtual assistant based on its chat dialog(s); a set of managers 126 that analyze and collect data according to the metrics 125; and a score generator and comparator 127 that generates scores for the VA chat dialogs 123 and compares these scores.

Computer system 100 utilizes well known virtual addressing mechanisms that allow the programs of computer system 100 to behave as if they only have access to a large, contiguous address space instead of access to multiple, smaller storage entities such as main memory 120 and local mass storage device 155. Therefore, while data 121, operating system 122, VA chat dialogs 123 and virtual assistant comparison tool 124 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Processor 110 also executes the virtual assistant comparison tool 124.

Although computer system 100 is shown to contain only a single processor and a single system bus, those skilled in the art will appreciate that a virtual assistant comparison tool as described herein may be practiced using a computer system that has multiple processors and/or multiple buses. In addition, the interfaces that are used preferably each include separate, fully programmed microprocessors that are used to off-load compute-intensive processing from processor 110. However, those skilled in the art will appreciate that these functions may be performed using I/O adapters as well.

Display interface 140 is used to directly connect one or more displays 165 to computer system 100. These displays 165, which may be non-intelligent (i.e., dumb) terminals or fully programmable workstations, are used to provide system administrators and users the ability to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect computer system 100 to other computer systems or workstations 175 via network 170. Computer systems 175, shown as CS1, . . . , CSN in FIG. 1, represent computer systems that are connected to the computer system 100 via the network interface 150 in a computer cluster. Network interface 150 broadly represents any suitable way to interconnect electronic devices, regardless of whether the network 170 comprises present-day analog and/or digital techniques or via some networking mechanism of the future. Network interface 150 preferably includes a combination of hardware and software that allows communicating on the network 170. Software in the network interface 150 preferably includes a communication manager that manages communication with other computer systems 175 via network 170 using a suitable network protocol. Many different network protocols can be used to implement a network. These protocols are specialized computer programs that allow computers to communicate across a network. TCP/IP (Transmission Control Protocol/Internet Protocol) is an example of a suitable network protocol that may be used by the communication manager within the network interface 150. In one suitable implementation, the network interface 150 is a physical Ethernet adapter.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

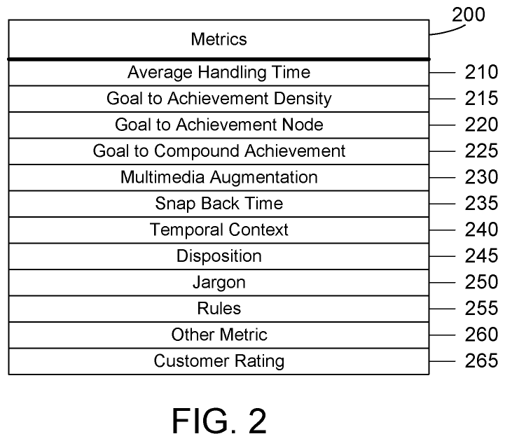

Referring to FIG. 2, metrics 200 are shown as possible examples of metrics 125 shown in FIG. 1. Metrics 200 include: Average Handling Time 210; Goal to Achievement Density 215; Goal to Achievement Node 220; Goal to Compound Achievement 225; Multimedia Augmentation 230; Snap Back Time 235; Temporal Context 240; Disposition 245; Jargon 250; Rules 255; Other Metric 260; and Customer Rating 265. The Average Handling Time 210 is calculated as the average time to handle a chat dialog. The Goal to Achievement Density 215 is calculated as the word density in a chat dialog. The Goal to Achievement Node 220 is a node that results in resolving the user's request. The Goal to Compound Achievement 225 is the ability of the virtual assistant to respond to compound queries. Multimedia Augmentation 230 is extracted from a chat dialog based on the virtual assistant's ability to respond to multimedia. Snap Back Time 235 is computed as the time to return a chat conversation to the context. Temporal Context 240 is the ability to hop to temporal nodes related to the context. Disposition 245 is the ability of the virtual assistant to provide a response with emotion that aligns with the user's emotion. Jargon 250 is the ability to respond to abbreviations and domain-specific terms. Rules 255 is the ability of a virtual assistant to respond to mathematical verbose and rule-based verbose. Other metric 260 is any other suitable metric that could be used for evaluating and comparing virtual assistants. Customer rating 265 is a value that is provided by the user in a chat dialog to indicate the user's satisfaction with the virtual assistant. The metrics 200 shown in FIG. 2 are shown by way of example. The disclosure and claims herein expressly extend to any suitable metric for measuring performance of one or more virtual assistants.

The metrics 200 in FIG. 2 are most preferably computed based on analyzing chat dialogs of different virtual assistants. Threshold values could then be derived based on the analysis, or could be specified by a user, based on the analyzed chat dialogs. A score for each metric may then be determined based on the threshold values. In the alternative, the user could specify threshold values for one or more of the metrics, with each metric that has a specified threshold value being evaluated based on the specified threshold value.

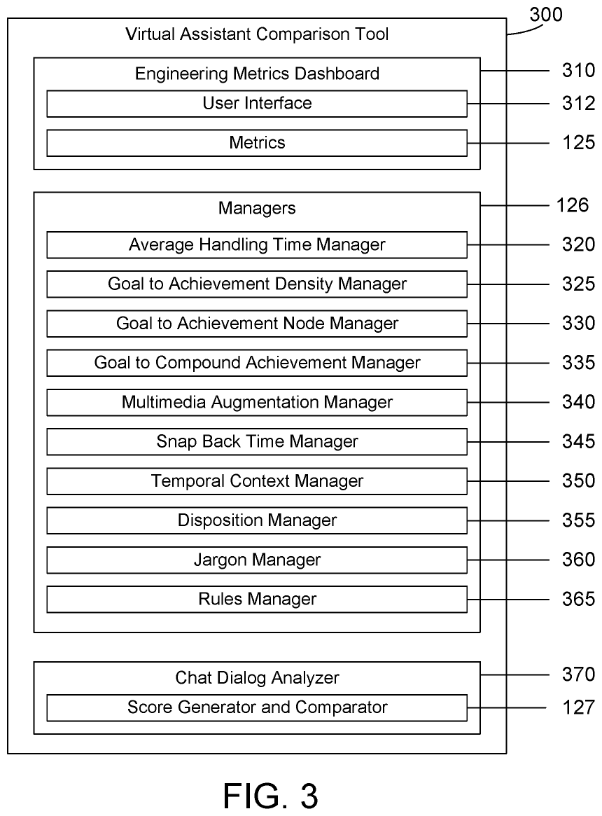

FIG. 3 shows a virtual assistant comparison tool 300, which is one specific configuration for the virtual assistant comparison tool 124 in FIG. 1 according to a preferred embodiment. The virtual assistant comparison tool 300 preferably includes an engineering metrics dashboard 310, multiple managers 126, and a chat dialog analyzer 370. The engineering metrics dashboard 310 is preferably a software entity that provides a user interface 312 and one or more metrics 125, such as metrics 200 shown in FIG. 2. The user interface allows a user to select one or more metrics that are used in analyzing and evaluating multiple virtual assistants by analyzing one or more chat dialogs for each of the multiple virtual assistants. The user interface 312 also allows a user to specify a weight for each of the selected metrics, thereby providing weighted selected metrics. The weighting allows the user to emphasize metrics the user feels are more important. The selection of metrics and the specification of weights allows the user to fine-tune the virtual assistant comparison tool so it provides a comparison of multiple virtual assistants based on the weighted selected metrics specified by the user.

The managers 126 preferably include an Average Handling Time Manager 320; a Goal to Achievement Density Manager 325; a Goal to Achievement Node Manager 330; a Goal to Compound Achievement Manager 335; a Multimedia Augmentation Manager 340; a Snap Back Time Manager 345; a Temporal Context Manager 350; a Disposition Manager 355; a Jargon Manager 360; and a Rules Manager 365. Note the managers 320-365 in FIG. 3 correspond to the metrics 210-255 in FIG. 2. In the most preferred implementation, each manager in FIG. 3 computes the corresponding metric in FIG. 2 for each chat dialog when that metric has been selected, which then allows comparing chat dialogs according to the selected metrics.

The Average Handling Time Manager 320 extracts average handling time across chat dialogs, computes a threshold for compliance, and computes based on the threshold a score based on the time which different virtual assistants take to handle a chat dialog. It compares two virtual assistants and determines how much time each virtual assistant takes to resolve an issue and close the session for the same issue. A score is calculated by the Average Handling Time Manager 320 based on the time a virtual assistant takes to handle an issue.

The Goal to Achievement Density Manager 325 extracts requests/responses from a chat dialog, computes the density of word definition, and determines a score for a virtual assistant based on the word density in requests/responses in the chat dialog. It compares chat dialogs from multiple virtual assistants and finds how lengthy the conversation is, and whether a virtual assistant is able to resolve an issue and close a session for the same issue with less word density. A score is calculated based on the word density.

The Goal to Achievement Node Manager 330 extracts requests/responses from a chat dialog, and computes the nodes used to achieve the goal. It could be that nodes were used but the goal was never achieved. This parameter will determine whether a corresponding node is present in the virtual assistant for a specific request/response, and a score is calculated based on the result obtained. The Goal to Achievement Node Manager 330 compares chat dialogs of multiple virtual assistants and finds whether the goal achievement node was present in the virtual assistant and was is able to resolve/help/satisfy the user with an appropriate reply. A score is calculated based on whether the achievement node is present or not in a virtual assistant.

The Goal to Compound Achievement Manager 335 extracts requests/responses from a chat dialog and determines the ability to respond to compound queries. This parameter will determine whether a virtual assistant has the capability to respond to complex queries, and a score is calculated based on the result. The Goad to Compound Achievement Manager 335 compares two virtual machines and finds whether a node tree can handle multiple conditions and gets triggered to achieve the goal. This manager determines whether a virtual assistant is able to resolve/help/satisfy the user with an appropriate reply. A score is calculated based on whether the compound achievement node is present or not.

The Multimedia Augmentation Manager 340 extracts requests/responses from a chat dialog and determines the ability to respond to multimedia. This parameter will calculate a score based on the virtual assistant's ability to respond to multimedia. The multimedia augmentation manager 340 compares two virtual assistants, and finds whether a virtual assistant understands multimedia input like a picture, video, text, PowerPoint file, etc., and checks whether a virtual assistant is able to resolve/help/satisfy the user with an appropriate reply. A score is calculated based on the response of the VA and customer satisfaction.

The Snap Back Time Manager 345 extracts the requests/responses from a chat dialog and logs and computes the time to return the conversation to the context. This parameter will calculate a score based on the time a virtual assistant takes to switch from chit chat to the intent of the chat dialog. Say for example, the virtual assistant is helping a customer. The customer is chit chatting with some topics like “Today is a hot day.” The Snap Back Time Manager determines how long it takes the virtual assistant to switch the context of the chat dialog to the intent of the discussion and reply appropriately. A score is calculated based on the response of the virtual assistant and customer satisfaction.

The Temporal Context Manager 350 extracts the requests/responses from a chat dialog and computes the ability to hop to temporal nodes related to the context. This parameter will calculate a score based on the virtual assistant's ability to recognize previous contexts and link to the present conversation. For example, let's assume the virtual assistant is helping a customer who is frustrated with a product manual. She has trouble in installing the product and has asked for help repeatedly with a virtual assistant. Whether the virtual assistant is able to relate the previous context, background and reply appropriately with a message instead of asking for details again. For example, certain info could be extracted from past chat dialogs, such as “Your desktop is Intel Processor with 32 GB RAM”, etc. A score is calculated based on the response of the virtual assistant and customer satisfaction, and by comparing previous chat history and present chat history.

The Disposition Manager 355 extracts the requests/responses from a chat dialog and computes the ability of the virtual assistant respond in a way that aligns with emotions of the user. This parameter will determine whether a virtual assistant can understand the user's emotions and respond with emotions. A score is calculated based on the result. For example, let's assume the virtual assistant is helping a customer who is frustrated with a product. The Disposition Manager 355 determines whether the virtual assistant is able to console the customer and reply appropriately with a message, such as “Sorry for the inconvenience,” “Please have patience,” or “Don't worry, we will help you in resolving the issue at the earliest.” A score is calculated based on the response of the virtual assistant and customer satisfaction.

The Jargon Manager 360 extracts the requests/responses from a chat dialog and computes the ability to respond to abbreviations and domain specific terms. This parameter will determine whether a virtual assistant can understand the abbreviations and terms in a chat dialog and it calculates a score based on the result. For example, if the virtual assistant is helping an employee with his pay slip and the employee is asking questions about abbreviations relating to his pay slip, the Jargon Manager 360 determines whether the virtual assistant is able to understand the abbreviations and answer the questions. This can be determined, for example, by analyzing the chat dialog and determining if the employee is happy with the response and is not asking the same question again and again and giving more details in explaining the issue. A score is calculated based on the response of the virtual assistant and customer satisfaction.

The Rules Manager 365 extracts the requests/responses from a chat dialog and computes the ability to respond to mathematical verbose and rule-based verbose. This parameter will calculate a score based on the virtual assistant's ability to respond based on mathematical or rule-based verbose. For example, if the virtual assistant is helping a patient who is a kid with symptoms like fever, the rules manager 365 determines whether the virtual assistant is able to find a medicine like Paracetamol and dosage appropriate for the kid's weight, age and symptoms. A score is calculated based on the response of the virtual assistant and customer satisfaction.

The Chat Dialog Analyzer 370 analyzes a plurality of chat dialogs from a plurality of virtual assistants, and generates a score for each of the plurality of chat dialogs using the selected metrics. In one specific implementation, the chat dialog analyzer 370 uses the managers 126 to analyze chat dialogs according to the selected metrics, with each manager that corresponds to a selected metric returning data to the chat dialog analyzer 370. The chat dialog manager includes a score generator and comparator 127 that compiles scores generated by each of the managers that correspond to metrics selected by a user into an overall score for a chat dialog, and the scores from multiple chat dialogs of the same virtual assistant may be added, averaged or otherwise compiled into an overall score for the virtual assistant. This process can be repeated for each of a plurality of virtual assistants. Once each of the plurality of virtual assistants have an overall score, the scores can be compared to determine which virtual assistant performed better based on the selected weighted metrics. The scores can thus be used to recommend one of the virtual assistants based on the metrics that were selected by the user.

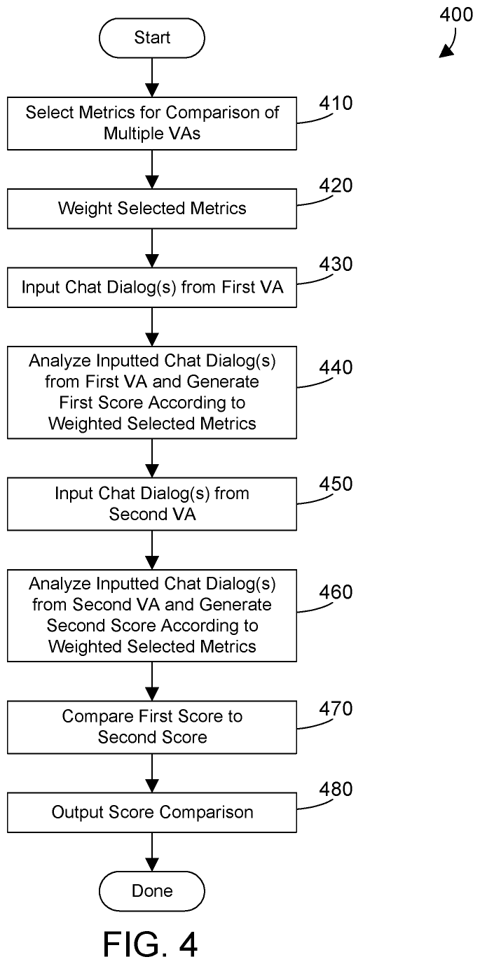

Referring to FIG. 4, a method 400 is used to compare multiple virtual assistants. A user selects metrics for comparison of multiple virtual assistants (step 410). The selected metrics may also be weighted (step 420). In one embodiment, the selected metrics are weighted by a user assigning weight values to each metric. In an alternative embodiment, weight values can be determined by a software tool that determines appropriate weight values based on a historical log of analyzed chat dialogs of one or more virtual assistants. Note step 420 of weighting the selected metrics is optional, and need not always be performed, but can be performed when needed. In addition, the selection of metrics for comparison in step 410 can be considered a type of weighting, because all metrics not selected in step 410 can be considered to have a weight of zero, while those metrics selected in step 410 can have non-zero weights assigned in step 420, or could have default weights assigned by the virtual assistant comparison tool.

One or more chat dialogs from a first virtual assistant are then input to the virtual assistant comparison tool (step 430), and are analyzed to generate a first score according to the weighted selected metrics (step 440). One or more chat dialogs from a second virtual assistant are then input to the virtual assistant comparison tool (step 450), and are analyzed to generate a second score according to the weighted selected metrics (step 460). The first score, which corresponds to chat session(s) of the first virtual assistant, is then compared with the second score, which corresponds to chat session(s) of the second virtual assistant (step 470). The score comparison is then output (step 480). Method 400 is then done.

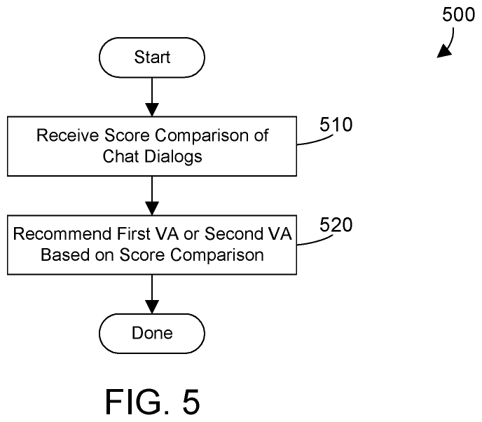

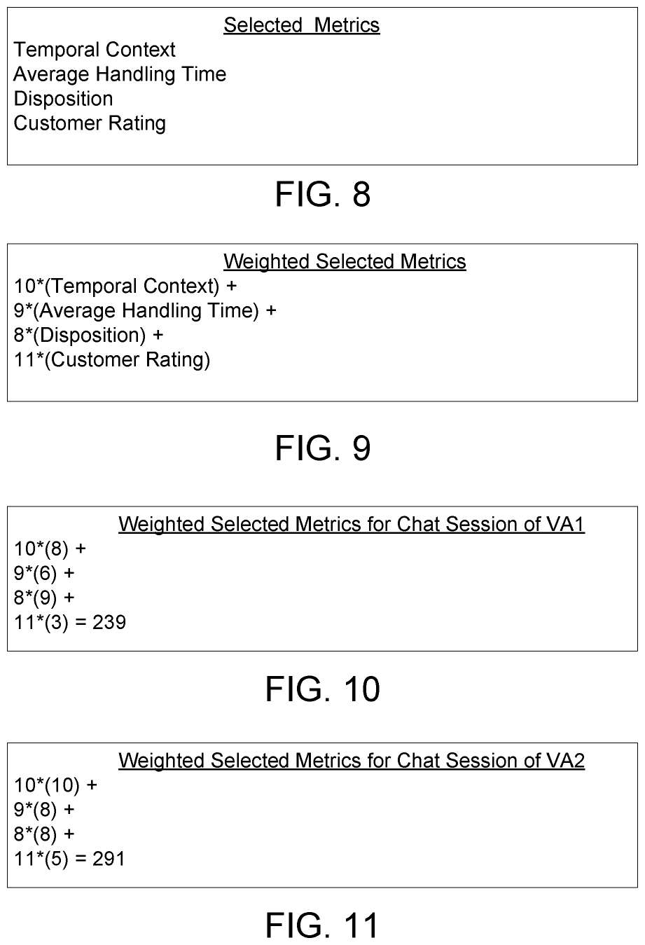

Method 500 in FIG. 5 shows how the score comparison output in step 480 in FIG. 8 can be used. The score comparisons of the chat dialogs are received (step 510). Either the first virtual assistant or the second virtual assistant are recommended based on the score comparison (step 520). Method 500 is then done. The combination of method 400 in FIG. 4 and method 500 in FIG. 5 allow analyzing one or more chat sessions for a first virtual assistant, analyzing one or more chat sessions for a second virtual assistant, then recommending based on the analysis one of the virtual assistants that is better according to the selected metrics. While FIGS. 4 and 5 are specific to analyzing and comparing two virtual assistants for the sake of illustration, the preferred embodiments herein expressly extend to analyzing more than two virtual assistants.

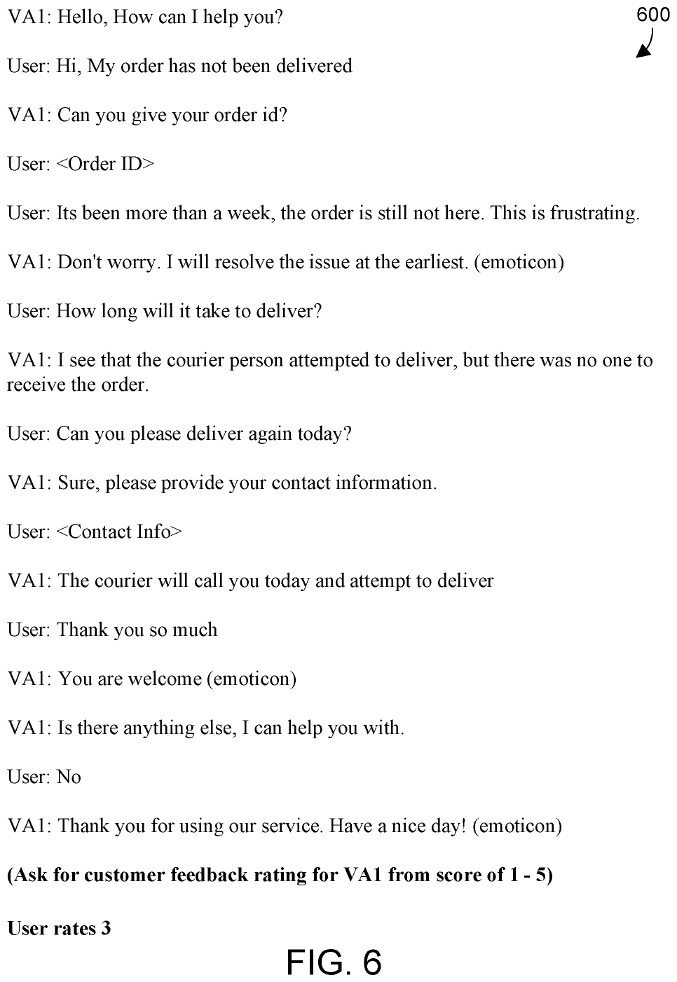

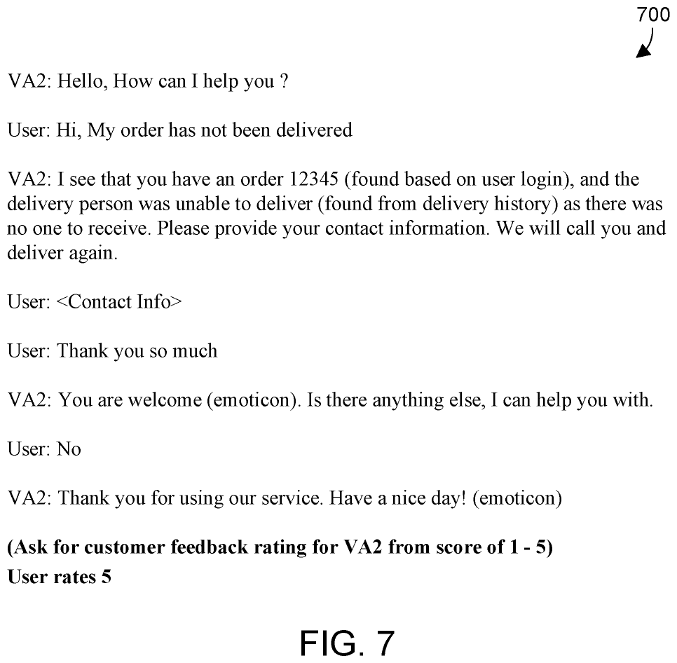

Examples are now provided to illustrate how the virtual assistant comparison tool can analyze and compare different virtual assistants. FIG. 6 shows a chat dialog 600 for a first virtual assistant labeled VA1 interacting with a user. FIG. 7 shows a chat dialog 700 for a second virtual assistant labeled VA2 interacting with a user. FIG. 8 shows metrics that are selected for analyzing VA1 and VA2. The selected metrics include Temporal Context, Average Handling Time, Disposition, and Customer Rating, as shown in FIG. 8. For this example, we assume the selected metrics in FIG. 8 were selected by a user who wants to compare VA1 to VA2. This could be done by the user interface 310 in FIG. 3 presenting a list of metrics to the user, with each metric having a selectable checkbox, and allowing the user to select from all of the list of metrics by clicking on the selectable checkboxes for Temporal Context, Average Handling Time, Disposition, and Customer Rating.

FIG. 9 shows the metrics selected in FIG. 8 after weighting. For this example, we assume the user that selected the selected metrics in FIG. 8 also assigns numerical weighting values as shown in FIG. 9. As shown in FIG. 9, the user has assigned a weight of 10 to the Temporal Context metric; a weight of 9 to the Average Handling Time metric; a weight of 8 to the Disposition metric; and a score of 11 to the Customer Rating metric. We assume for this example the managers corresponding to the selected metrics analyze the chat session 600 for VA1 in FIG. 6, and the Temporal Context Manager returns a score of 8; the Average Handling Time Manager returns a score of 6; and the Disposition Manager returns a score of 9. The Customer Rank is not produced by a manager, but is a value in the chat session itself, which is shown at the bottom of FIG. 6 to have a value of 3. Each of these metrics are multiplied by their respective weights shown in FIG. 9, resulting in an overall score for chat session 600 for VA1 of 239, as shown in FIG. 10. A similar analysis is then performed by the same managers on chat session 700 for VA2 in FIG. 7, with the resulting weights and values shown in FIG. 11, resulting in an overall score for chat session 700 for VA2 of 291. A comparison of these two overall scores leads to a recommendation of VA2 because the score of 291 for VA2 is greater than the score of 239 for VA1.

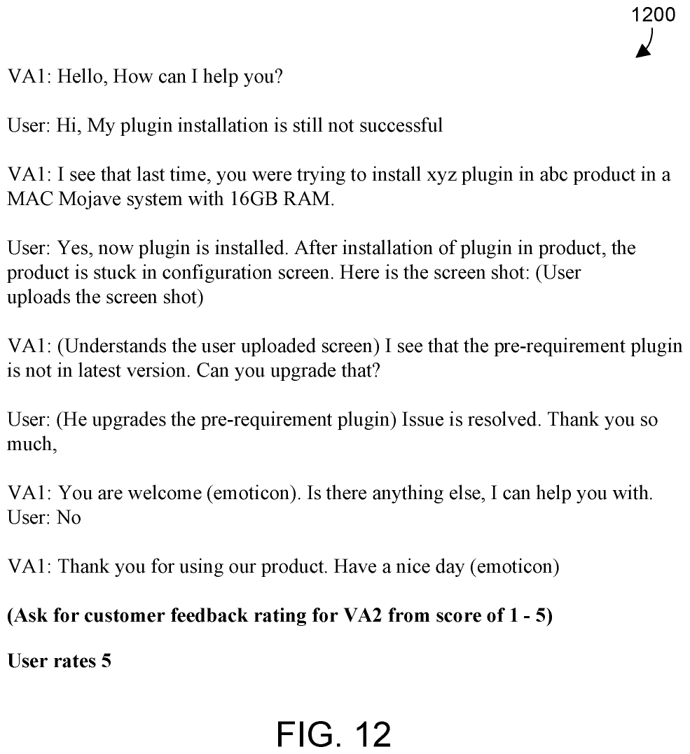

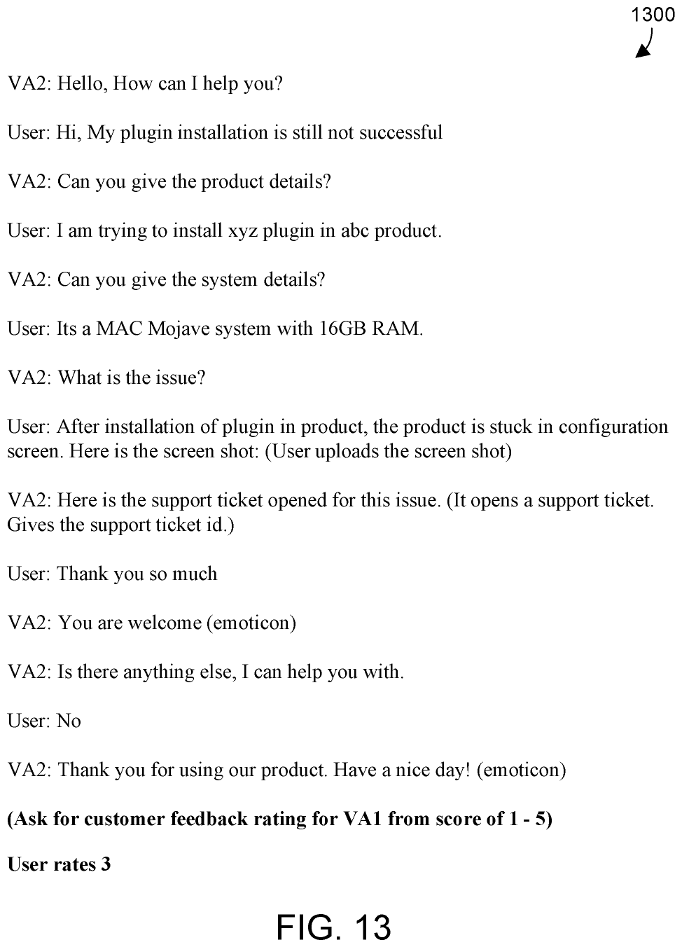

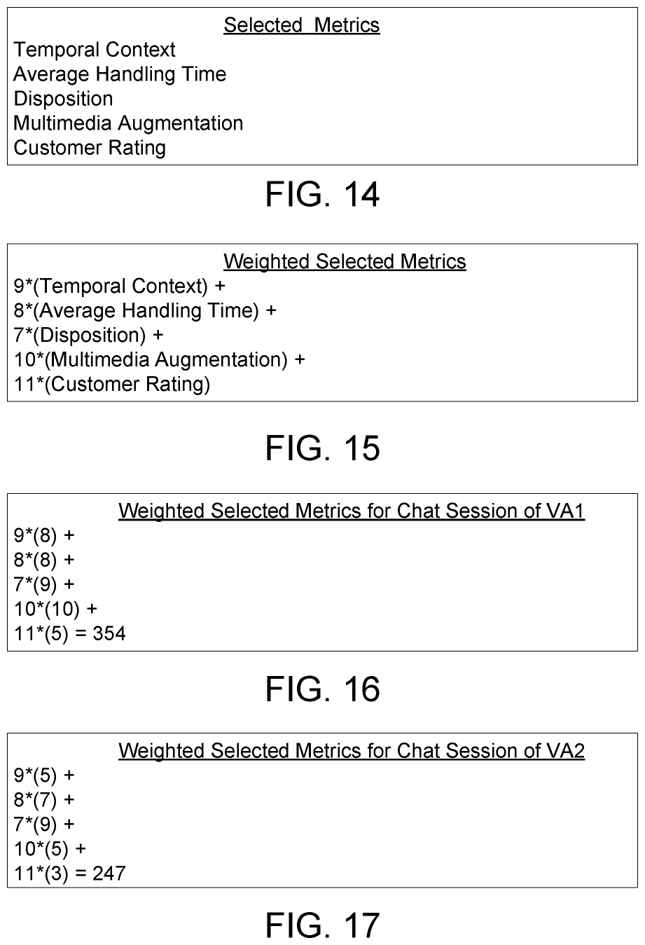

In a second example, a chat dialog 1200 of a first virtual assistant VA1 in FIG. 12 is compared with a chat dialog 1300 of a second virtual assistant VA2 in FIG. 13. A user selects the metrics shown in FIG. 14, and provides weight values for each of the metrics as shown in FIG. 15. We assume the managers for Temporal Context, Average Handling Time, Disposition, and Multimedia Augmentation produce scores of 8, 8, 9 and 10, respectively, for the chat session 1200 for VA1 shown in FIG. 12, and the customer rating is 5, resulting in the weighted selected metrics in FIG. 16 that produce an overall score of 354 for VA1. We further assume the managers for Temporal Context, Average Handling Time, Disposition and Multimedia Augmentation produce scores of 5, 7, 9 and 5, respectively, for the chat session 1300 for VA1 shown in FIG. 13, and the customer rating is 3, resulting in the weighted selected metrics in FIG. 17 that produce an overall score of 247 for VA2. Based on these scores, the virtual assistant comparison tool returns a recommendation for VA1.

While the specific examples in FIGS. 6-17 show comparing one chat dialog each from two virtual assistants, the disclosure and claims herein expressly extend to analyzing multiple chat dialogs for a virtual assistant, and extend to comparing any suitable number of virtual assistants by comparing any suitable number of chat sessions for each virtual assistant.

Because the virtual assistant comparison tool functions according to selected metrics, a user using the virtual assistant comparison tool can perform various analyses based on different selected metrics and weight values to see how the scores and recommendations differ based on these different metrics and weight values. The user can thus run several different analyses based on different selected metrics and weight values, thereby giving the user a powerful tool for comparing virtual assistants under a wide variety of different criteria.

The disclosure and claims herein support an apparatus comprising: at least one processor; a memory coupled to the at least one processor; a virtual assistant comparison tool residing in the memory and executed by the at least one processor, the virtual assistant comparison tool defining a plurality of metrics that may be selected by a user for comparing virtual assistants, the virtual assistant comparison tool comprising: a user interface that allows the user to select which of the plurality of metrics to use to provide selected metrics; and a chat dialog analyzer that analyzes a plurality of chat dialogs from a plurality of virtual assistants, and generates a score for each of the plurality of chat dialogs using the selected metrics.

The disclosure and claims herein further support an article of manufacture comprising software stored on a computer readable storage medium, the software comprising: a virtual assistant comparison tool that defines a plurality of metrics that may be selected by a user for comparing virtual assistants, the virtual assistant comparison tool comprising: a user interface that allows the user to select which of the plurality of metrics to use to provide selected metrics; and a chat dialog analyzer that analyzes a plurality of chat dialogs from a plurality of virtual assistants, and generates a score for each of the plurality of chat dialogs using the selected metrics.

The disclosure and claims herein additionally support a method for comparing a plurality of virtual assistants, the method comprising: defining a plurality of metrics that may be selected by a user for comparing virtual assistants; providing a user interface that allows the user to select which of the plurality of metrics to use to provide selected metrics; analyzing a plurality of chat dialogs from a plurality of virtual assistants using the selected metrics; and generating a score for each of the plurality of chat dialogs using the selected metrics.

A system and method compare performance of virtual assistants. A user selects metrics for evaluating two or more virtual assistants, and these metrics may be weighted by the user. One or more chat sessions from each virtual assistant are then analyzed using the weighted metrics to generate a score for each chat session. The scores of chat sessions of different virtual assistants are then compared according to the selected weighted metrics, and a recommendation of a virtual assistant may be made based on the score comparison. The evaluation of multiple virtual assistants allows comparing these virtual assistants to determine which provides the better customer service according to the selected weighted metrics.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. An apparatus comprising:
at least one processor;
a memory coupled to the at least one processor;
a virtual assistant comparison tool residing in the memory and executed by the at least one processor, the virtual assistant comparison tool defining a plurality of metrics that may be selected by a user for comparing virtual assistants, the virtual assistant comparison tool comprising:
a user interface that allows the user to select which of the plurality of metrics to use to provide selected metrics; and
a chat dialog analyzer that analyzes a plurality of chat dialogs from a plurality of virtual assistants, and generates a score for each of the plurality of chat dialogs using the selected metrics.

2. The apparatus of claim 1 wherein the user interface allows the user to specify a weight value for each of the selected plurality of metrics to provide weighted selected metrics, wherein the chat dialog analyzer generates a score for each of the plurality of chat dialogs using the weighted selected metrics.

3. The apparatus of claim 1 wherein the virtual assistant comparison tool compares scores of the plurality of chat dialogs and recommends one of the plurality of virtual assistants based on the compared scores.

4. The apparatus of claim 1 wherein the plurality of metrics comprises average handling time.

5. The apparatus of claim 4 wherein the plurality of metrics further comprises:
goal to achievement density;
goal to achievement node; and
goal to compound achievement.

6. The apparatus of claim 5 wherein the plurality of metrics further comprises:
multimedia augmentation;
snap back time;
temporal context; and
disposition.

7. The apparatus of claim 6 wherein the plurality of metrics further comprises:
jargon;
rules; and
customer rank selected by the user in a chat dialog.

8. An article of manufacture comprising software stored on a computer readable storage medium, the software comprising:
a virtual assistant comparison tool that defines a plurality of metrics that may be selected by a user for comparing virtual assistants, the virtual assistant comparison tool comprising:
a user interface that allows the user to select which of the plurality of metrics to use to provide selected metrics; and
a chat dialog analyzer that analyzes a plurality of chat dialogs from a plurality of virtual assistants, and generates a score for each of the plurality of chat dialogs using the selected metrics.

9. The article of manufacture of claim 8 wherein the user interface allows the user to specify a weight value for each of the selected plurality of metrics to provide weighted selected metrics, wherein the chat dialog analyzer generates a score for each of the plurality of chat dialogs using the weighted selected metrics.

10. The article of manufacture of claim 8 wherein the virtual assistant comparison tool compares scores of the plurality of chat dialogs and recommends one of the plurality of virtual assistants based on the compared scores.

11. The article of manufacture of claim 8 wherein the plurality of metrics comprises average handling time.

12. The article of manufacture of claim 11 wherein the plurality of metrics further comprises:
goal to achievement density;
goal to achievement node; and
goal to compound achievement.

13. The article of manufacture of claim 12 wherein the plurality of metrics further comprises:
multimedia augmentation;
snap back time;
temporal context;
disposition;
jargon;
rules; and
customer rank selected by the user in a chat dialog.

14. A method for comparing a plurality of virtual assistants, the method comprising:
defining a plurality of metrics that may be selected by a user for comparing virtual assistants;
providing a user interface that allows the user to select which of the plurality of metrics to use to provide selected metrics;
analyzing a plurality of chat dialogs from a plurality of virtual assistants using the selected metrics; and
generating a score for each of the plurality of chat dialogs using the selected metrics.

15. The method of claim 14 wherein the user interface allows the user to specify a weight value for each of the selected plurality of metrics to provide weighted selected metrics, wherein analyzing the plurality of chat dialogs from the plurality of virtual assistants and generating the score for each of the plurality of chat dialogs uses the weighted selected metrics.

16. The method of claim 14 further comprising:
comparing scores of the plurality of chat dialogs; and
recommending one of the plurality of virtual assistants based on the compared scores.

17. The method of claim 14 wherein the plurality of metrics comprises average handling time.

18. The method of claim 17 wherein the plurality of metrics further comprises:
goal to achievement density;
goal to achievement node; and
goal to compound achievement.

19. The method of claim 18 wherein the plurality of metrics further comprises:
multimedia augmentation;
snap back time;
temporal context; and
disposition.

20. The method of claim 19 wherein the plurality of metrics further comprises:
jargon;
rules; and
customer rank selected by the user in a chat dialog.
